(19) United States
(12) Patent Application Publication
(10) Pub. No.: US 2010/0028781 A1
(43) Pub. Date: Feb. 4, 2010

(54) ELECTRODE PACK OF AN ELECTRICHEMICAL CELL AND ELECTROCHEMICAL CELL WITH AN ELECTRODE PACK

(75) Inventor: Richard Aumayer, Diekholzea (DE)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 12/442,442

(22) PCT Filed: Dec. 21, 2007
(86) PCT No.: PCT/EP2007/064500

§ 371 Date: Mar. 23, 2009

(30) Foreign Application Priority Data
Jan. 10, 2007 (DE) 10 2007 001 574.9

(51) Int. Cl. H01M 2/16

(52) U.S. Cl. 429/246

(57) ABSTRACT

The invention relates to an electrode pack of an electrochemical cell (40), which has en essentially flat design and comprises laterally protruding connecting lugs (24, 26) for making electrical contact. According to the invention, a first carrier film (16) coated with an electrochemical active mass (18) and a second carrier film (20) coated with an electrochemical active mass (22) are separated by a first separator film (12), characterized in that the first carrier film (16) protrudes on the longitudinal side along the longitudinal extension (30) of the separator film (12) while the second carrier film (20) protrudes on the opposite longitudinal side of the separator film (12).

### PRIOR ART

The invention is based on an electrode pack of an electrochemical cell and an electrochemical cell with an electrode pack as recited in the preambles to the independent claims.

In sophisticated traction systems such as hybrid vehicles, powerful electrical storage cells are required. There are a wide variety of known lithium-ion cells used for this purpose. They are frequently round or prismatic, with stacked, wound, or folded electrode packs. As a reasonably priced and powerful system, there are known lithium-ion batteries of the kind described in EP 1 577 973 A1, which describes so-called “coffee bag” cells embodied in the form of rectangular, flat cells. In cells of this kind, the electrode packs are contained in a laminated metal foil that is adapted to the electrode pack. The cells are correspondingly soft. They are usually assembled into a plurality of modules and electrically connected in parallel and/or in series. For the function of the cell, it is necessary to maintain a predetermined distance between the electrodes for the entire duration of their operation. The strain induced by charging and discharging cycles and temperature cycles can lead to a change in this distance, which degrades the performance of the cell. In addition, in order for such cells to be used in mass-produced products such as hybrid vehicles, the production of the cells must be suitable for mass production.

### DISCLOSURE OF THE INVENTION

The invention is based on an electrode pack of an electrochemical cell that is embodied as essentially flat and has laterally protruding terminal lugs for providing electrical contact.

According to one proposed embodiment, a first support film coated with an electrochemically active substance and a second support film coated with an electrochemically active substance are separated by a first separator film, with the first support film protruding from one longitudinal side along a longitudinal span of the separator film and the second support film protruding from the opposite longitudinal side of the separator film. The support films protrude transversely in relation to the longitudinal span of the separator film. The support films are preferably composed of metal, e.g. sheet aluminum, sheet copper, or the like. They can be coated with the active substance on one or both sides. The support films, which constitute the anode and cathode of the electrochemical cell, are preferably coated with the active substance in a region that is covered by the separator film. The electrochemical cell is preferably embodied in the form of a lithium-ion cell. The active substance then typically contains a lithium salt. The preferred arrangement of support films in relation to each other permits the electrode packs to be folded in a continuous production process. The separator films can be composed, for example, of a plastic. Examples of suitable materials include polypropylene, polyethylene, or the like.

Preferably, the first support film can be situated on a second separator film. This permits the composite of separator and support films to be folded, thus making it possible to reliably avoid short circuits.

The separator film can also advantageously be embodied in pocket-like fashion, with at least one of the support films dipping into the pocket-like separator film. It is also possible for both support films to be situated inside a pocket-like separator film. This also makes it possible to reliably avoid short circuits during the folding.

Preferably, the composite of separator and support films can be folded in zigzag fashion along the longitudinal span. The preferred manufacturing method thus permits a procedure that occurs in an ongoing fashion in lieu of a cyclical one and is therefore advantageous for mass production. This is primarily true when working with very large electrode surfaces of very thin electrodes, i.e. support films. In the manufacture of electrode packs, this applies to the processes of winding or folding as opposed to stacked electrode packs. The continuous production of the electrode packs makes it possible to use them in so-called laminated cells and to assure a stability of the electrode pack. In addition to production related advantages, the improved stability of the electrodes also yields functional advantages for the cells. With the folding, the electrode pack can remain as thin as possible, which is advantageous for heat dissipation from the interior of the cell and therefore for its long-term stability.

The invention is also based on an electrochemical cell with an electrode pack in which the cell is embodied as essentially flat and has laterally protruding terminal lugs for providing electrical contact.

According to one proposed embodiment, a first support film coated with an electrochemically active substance and a second support film coated with an electrochemically active substance are separated by a first separator film, with the first support film protruding from one longitudinal side along a longitudinal span of the separator film, the second support film protruding from the opposite longitudinal side of the separator film, and an output conductor being attached to the protruding support films. The support film is embodied as electrically conductive, e.g. is composed of metal, while the separator film is preferably a plastic film. The cell is preferably embodied in the form of a lithium-ion cell.

Preferably, the composite of separator and support films can be folded in zigzag fashion along the longitudinal span to form the electrode pack. The folding can preferably occur so that there is always a separator film on the outside of the folded electrode pack.

The protruding parts of the support films can be advantageously covered with an insulator outside of the output conductors. It is then also possible for a metal foil, which is not laminated to an insulation layer, to be used as an outer skin for the cell.

The output conductors can protrude transversely in relation to the longitudinal span of the support films. The output conductors can be attached by means of soldering or welding to the parts of the support films protruding from the separator films. The dimensioning of the output conductors is appropriately matched to an expected decrease in performance. It is thus possible to improve a leak tightness of the cell. The protruding regions of the support films that are not attached to the output conductors can be advantageously covered with an insulation. It is thus possible to use a non-laminated metal foil as the outer skin of the cell.

If the electrode pack is embodied with a length greater than its height, then the electrode pack can be embodied as thin enough to assure a reliable heat dissipation from the interior of the cell, for example during the charging or discharging of cells.

If the electrode pack is provided with a stabilization that stabilizes the distance between the support films in the folded state, it is then possible to maintain a constant distance between electrodes and a high functional stability of the cell over the service life of the cell, even in the presence of powerful stress. The stabilization can be provided by wrapping or by attaching plastic clamps or the like. It is thus possible to maintain the original distance of the support films from one another, i.e. the distance between the electrodes in the electrode pack, and to prevent the active substance on the support film from drying out. Otherwise, cavities could form that the existing electrolyte would be insufficient to fill, thus causing the active substance on the support film to dry out.

Preferably, the electrode pack is sealed with an outer skin. This is attached, e.g. welded, around the electrode pack in the most continuous way possible.

The electrochemical cell according the invention is particularly suited for use in hybrid vehicles, for batteries in the industrial sector, or also for other applications such as electrically operated wheelchairs, bicycles provided with an electrical auxiliary drive (motor-assisted bicycles), forklifts, or driverless transportation systems.

### BRIEF DESCRIPTION OF THE DRAWINGS

Other advantages ensue from the following description of the drawings. The drawings show exemplary embodiments of the invention. Those skilled in the art will also consider individually the defining characteristics disclosed in combination in the drawings, the description, and the claims and will also unite them into other meaningful combinations.

FIGS. 1a-c show a schematic, exploded top view of a composite of support films and separator films of a preferred electrode pack (FIG. 1a), a top view of one end of an alternative embodiment with a pocket-like separator film and support films coated on one side (FIG. 1b), and an alternative embodiment with support films coated on both sides (FIG. 1c);

FIGS. 2a, 2b show a side view of a preferred folded electrode pack (FIG. 2a) and a top view of the electrode pack (FIG. 2b);

FIGS. 3a, 3b show a side view of a terminal lug on a preferred electrode pack (FIG. 3a) and an oblique view of a folded electrode pack with a terminal lug and insulation for protruding regions of the support films (FIG. 3b); and

FIGS. 4a, 4b show side views of a preferred electrochemical cell (FIG. 4a) and a known cell (FIG. 4b) as a comparison.

### EMBODIMENTS OF THE INVENTION

Components that are the same or similar have been provided with the same reference numerals in the drawings.

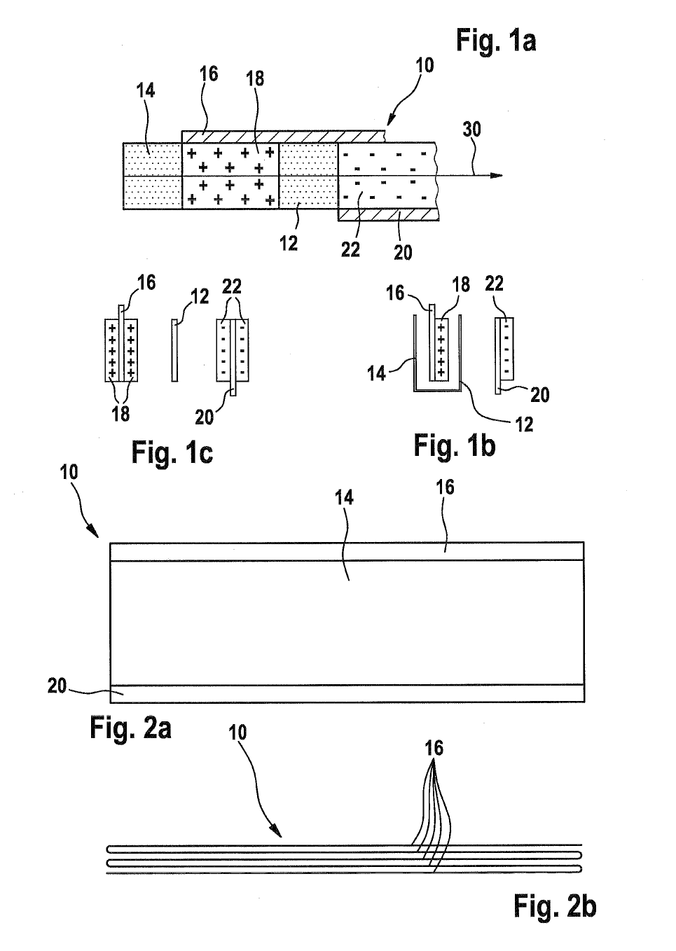

FIG. 1a is an exploded top view of a composite of support films 16, 20 and separator films 12, 14 of a preferred electrode pack 10 belonging to an electrochemical cell that is not shown. FIG. 1b is a top view of one end of an alternative embodiment with a pocket-like separator film 14, with the support films 16 and 20 being coated with an electrochemically active substance 18, 22 on one side. FIG. 1c shows an embodiment in which the support films 16 and 20 are each coated with an electrochemically active substance 18, 22 on both sides (spacing distances not shown to scale).

The first support film 16 is coated with the electrochemically active substance 18 and the second support film 20 is coated with the electrochemically active substance 22. A separator film 12 is positioned between the two support films 16, 20. The first support film 16 rests on a separator film 14. The support films 16, 20 are slightly taller than the separator films 12, 14, with the first support film 16 protruding upward and the second support film 20 protruding downward. The separator films 12, 14 cover the region coated with the active substances 18, 22. The separator films 12, 14 are provided as separate layers. The one support film 16 constitutes the positive electrode, for example, of the electrode pack 10 and the other support film 20 constitutes the negative electrode.

The electrode pack 10 is depicted stretched out longitudinally in the form of a long band with a longitudinal span 30. A sample electrode device for an 8 Ah cell of the type that can be used for example in a hybrid vehicle is approximately 6 m long and approximately 15 cm high, for example.

FIG. 1b shows an alternative embodiment in which the separator films 12, 14 are attached to one another and assembled to form a pocket-like layer; the separator films 12, 14 constitute legs of the pocket-like layer. The one support film 16 is inserted into the pocket-like layer and protrudes upward above the height of the separator films 12, 14.

FIG. 2a shows a side view of a preferred folded electrode pack 10 and FIG. 2b shows a top view of the electrode pack 10. The folded electrode pack 10 is longer than it is tall. Support films 16 and 20 protruding upward and downward, respectively, are visible at the longitudinal sides. In the top view, the zigzag folding of the films is visible, with the upward protruding support film 16. The protruding portions of the support films 16, 20 constitute the output conductors of the positive and negative electrodes of the electrode pack 10.

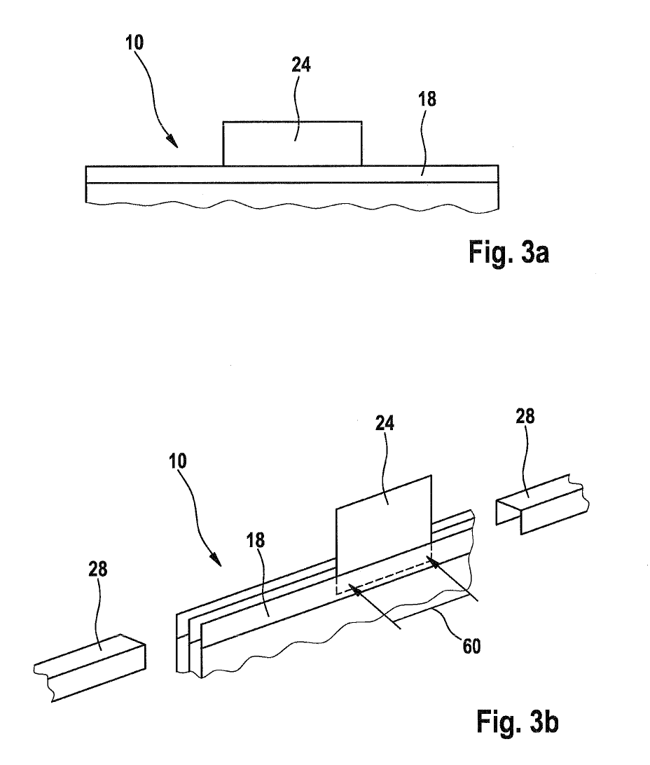

FIG. 3a shows an output conductor 24, which is connected to the protruding support films 16 of the electrode pack 10 (FIG. 1a) and protrudes from the broad side of the electrode pack 10. FIG. 3b is an oblique view of a folded electrode pack 10 with a terminal lug 24 and insulators 28 for protruding support film regions of the support film 16. The presence of the insulator 28 makes it possible to enclose the electrode pack 10 with a metal foil that is not laminated to a separate insulation layer. A region 60 from which the output conductor 24 protrudes is left uncovered by the insulator 28. The insulator 28 can be slid like a rail over the protruding regions of the support film 16. The protruding regions of the support film 20 that are not visible in the drawing (see FIG. 2a) are insulated in the same way.

Stabilizing means, not shown, can be provided, for example a wrapping tape and/or a plastic clamp that can serve to stiffen and stabilize the electrode pack 10, so that the distances between the support films and therefore the distances between the electrodes do not change during the service life of the cell into which the electrode pack 10 is inserted.

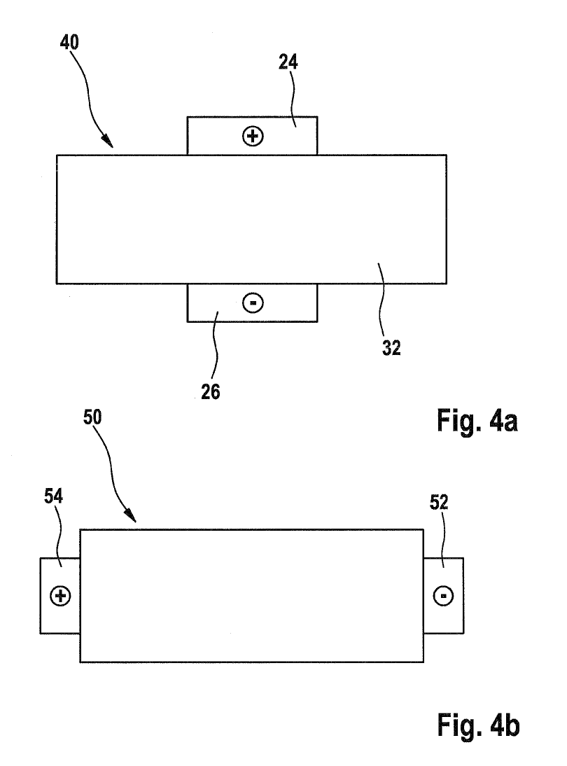

FIGS. 4a and 4b show a comparison between a preferred electrochemical cell 40 and a known cell 50. The preferred cell 40 is provided with an outer skin 32 that seals in an electrode pack that is not visible. The cell 40 is embodied as rectangular and is longer than it is tall. The output conductors 24, 26 protrude from the broad sides of the cell 40, perpendicular to the longitudinal span of the cell 40. By contrast, the known cell 50 does have a comparable cross-section, but its output conductors 52, 54 are situated in the conventional way at the narrow ends of the cell 50.

What is claimed is:

1. An electrode pack of an electrochemical cell (40) that is embodied as essentially flat and has laterally protruding terminal lugs (24, 26) for providing electrical contact,
wherein a first support film (16) coated with an electrochemically active substance (18) and a second support film (20) coated with an electrochemically active substance (22) are separated by a first separator film (12), with the first support film (16) protruding from one longitudinal side along a longitudinal span (30) of the separator film (12) and the second support film (20) protruding from the opposite longitudinal side of the separator film (12).

2. The electrode pack as recited in claim 1,
wherein the first support film (16) is situated on a second separator film (14).

3. The electrode pack as recited in claim 1,
wherein the separator film (12, 14) is embodied in pocket-like fashion, with at least one of the support films (16, 20) dipping into the pocket-like separator film (12, 14).

4. The electrode pack as recited in claim 1,
wherein the composite of separator and support films (12, 14; 16, 20) is folded in zigzag fashion along its longitudinal span (30).

5. An electrochemical cell with an electrode pack (10), in particular as recited in claim 1, in which the cell is embodied as essentially flat and has laterally protruding terminal lugs (24, 26) for providing electrical contact,
wherein a first support film (16) coated with an electrochemically active substance (18) and a second support film (20) coated with an electrochemically active substance (22) are separated by a first separator film (12), with the first support film (16) protruding from one longitudinal side along a longitudinal span (30) of the separator film (12) and the second support film (20) protruding from the opposite longitudinal side of the separator film (12) and a respective output conductor (24, 26) is attached to each of the protruding support films (16, 20).

6. The electrochemical cell as recited in claim 5,
wherein the composite of separator and support films (12, 14; 16, 20) is folded in zigzag fashion along the longitudinal span (30) to form the electrode pack (10)

7. The electrochemical cell as recited in claim 5, wherein the protruding parts of the support films (16, 20) are covered with an insulator (28) outside of the output conductors (24, 26).

8. The electrochemical cell as recited in claim 5,
wherein the output conductors (24, 26) protrude transversely in relation to the longitudinal span (30) of the support films (16, 20).

9. The electrochemical cell as recited in claim 5,
wherein the electrode pack (10) is embodied with a length greater than its height.

10. The electrochemical cell as recited in claim 5,
wherein the electrode pack (10) is provided with a stabilization that stabilizes the distance between the support films (16, 20) in the folded state.

11. The electrochemical cell as recited in claim 5,
wherein the electrode pack (10) is sealed with an outer skin (32).
